(19) United States
(12) Patent Application Publication
(10) Pub. No.: US 2006/0054183 A1
(43) Pub. Date: Mar. 16, 2006

(54) Method to reduce plasma damage during cleaning of semiconductor wafer processing chamber

(76) Inventors: Thomas Nowak, Cupertino, CA (US); Li-Qun Xia, Santa Clara, CA (US); Juan Carlos Rocha-Alvarez, Sunnyvale, CA (US); Brian Hopper, Redwood City, CA (US); Yuri Trachuk, Oak Ridge, TN (US); Ganesh Balasubramanian, Sunnyvale, CA (US); Daemian Raj, Sunnyvale, CA (US)

Correspondence Address: PATTERSON & SHERIDAN, LLP, 3040 POST OAK BOULEVARD, SUITE 1500, HOUSTON, TX, 77056, US

(21) Appl. No.: 11/096,986

(22) Filed: Apr. 1, 2005

Related U.S. Application Data
(60) Provisional application No. 60/605,067, filed on Aug. 27, 2004.

(51) Int. Cl. B08B 6/00

(52) U.S. Cl. 134/1.1; 134/22.1

(57) ABSTRACT

A method and apparatus for cleaning a semiconductor manufacturing chamber comprising introducing a heteroatomic fluorine containing gas to a remote plasma source, disassociating the heteroatomic fluorine containing gas, forming diatomic fluorine, transporting gas from the remote plasma source into a processing region of the chamber, and ionizing the diatomic fluorine with an in situ plasma.

### CROSS-REFERENCE TO RELATED APPLICATIONS

This application claims priority to U. S. Provisional Patent Application 60/605,067 filed Aug. 27, 2004 which is hereby incorporated by reference herein.

### BACKGROUND OF THE INVENTION

1. Field of the Invention

Embodiments of the present invention generally relate to an apparatus and method for cleaning a chamber for use in the semiconductor manufacturing industry.

2. Description of the Related Art

Semiconductor manufacturing chambers provide a wide variety of processes. Often, when depositing dielectric or other silicon containing layers on the semiconductor substrate, the residue from the deposition process collects on the walls and other surfaces of the manufacturing chambers. Silicon containing deposits may become friable and contaminate the surface of the substrate. Because the chambers are usually part of an integrated tool to rapidly process substrates, it is essential that maintenance and cleaning of the chambers require minimal time. To reduce the likelihood of contamination and thus improve the throughput of the chambers, effective and timely cleaning the surfaces of the chambers is desirable.

Currently, the mechanisms for removing the silicon containing deposits from the surfaces of the chamber include in situ RF plasma clean, remote plasma, or RF-assisted remote plasma clean. The in situ RF plasma clean method introduces a fluorine containing precursor to the deposition chamber and dissociates the precursor with RF plasma. The atomic fluorine neutrally charged particles clean by chemically etching the deposits. The in situ plasma generates an energetic mixture of charged and neutral species that accelerate the clean. Unfortunately, the plasma may attack clean surfaces, damaging the surfaces of the chamber and degrading the equipment performance by increasing the likelihood of defects from chamber contamination during the manufacturing process. The damage to the chamber surface that occurs during plasma cleaning may be substantial from both uneven removal of the deposits and from distortion that occurs when the chamber surfaces are exposed to non-uniform plasma. High power plasma can be difficult to apply uniformly throughout the chamber. Lower power plasma requires more process gas for cleaning, increasing the cost of operation and the likelihood of environmental damage.

Remote plasma with fluorine containing gas may be used for cleaning the chamber surfaces. However, the fluorine containing gas molecules that are dissociated in the remote plasma source include non-fluorine components that are reactive with chamber components. Reacting with the chamber components limits the activity of the dissociated ions, requiring additional process time or cleaning gas to thoroughly clean the chamber.

Currently, RF-assisted remote plasmas may also be used for cleaning. Combining the high precursor dissociation efficiency of the remote plasma clean with the enhanced cleaning rate of the in situ plasma may effectively clean the chamber surfaces. However, the combined plasma generation sources often form non uniform plasmas and also result in non uniform chemical distribution in the chamber. This non uniform plasma and chemical distribution lead to non uniform cleaning and surface degradation from overcleaning.

Chemical cleaning agents may also be introduced to the chamber. However, the time required for exposing the chamber to conventional chemical cleaning agents may be lengthy. The chemicals used for cleaning the chamber may have negative environmental consequences or may be difficult to transport in large quantities. Hence, it is desirable to provide a chamber cleaning method that requires low capital investment, features low raw material cost, and provides reduced damage to the chamber surfaces.

### SUMMARY OF THE INVENTION

The present invention generally provides a method for cleaning a semiconductor manufacturing chamber comprising introducing a heteroatomic fluorine containing gas to a remote plasma source, disassociating the atoms within the heteroatomic fluorine containing gas, forming diatomic fluorine, transporting diatomic fluorine from the remote plasma source into a processing region of the chamber, and ionizing the diatomic fluorine with an in situ plasma.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic of a chamber configured to have a remote plasma region and a processing region.

### DETAILED DESCRIPTION

The present invention provides a method and an apparatus to clean a semiconductor processing chamber.

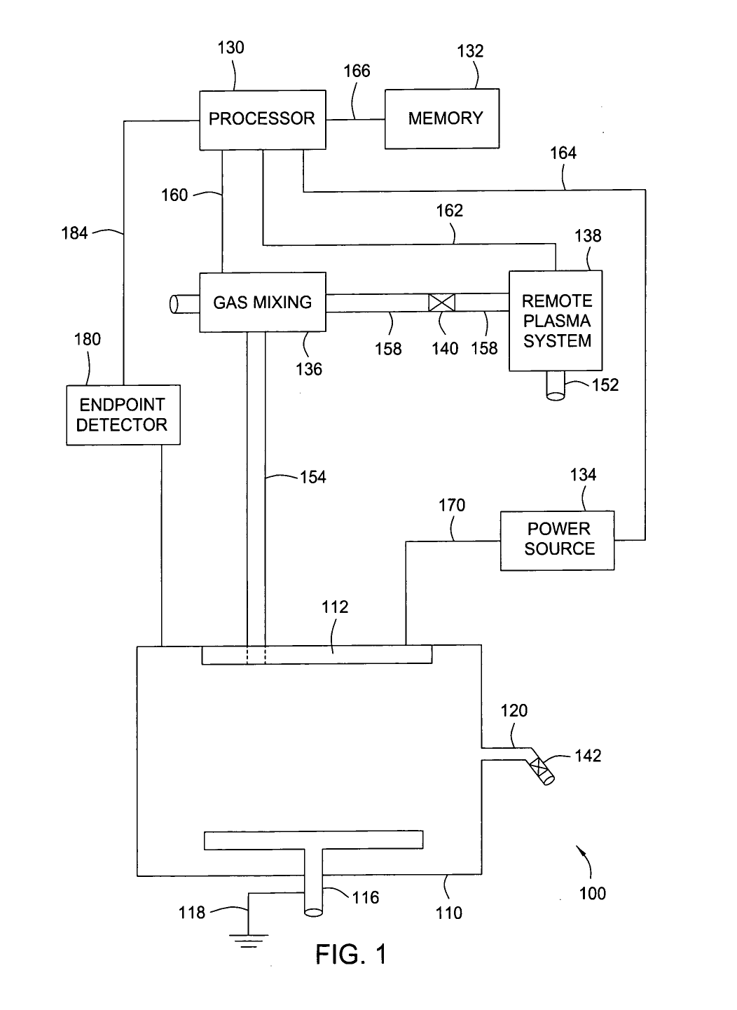

FIG. 1 illustrates a sectional view of a processing chamber with a cleaning system 100. The cleaning system 100 includes a process chamber 110 and a remote plasma system 138. The process chamber 110 contains a faceplate 112, a substrate support 116 that has a ground 118, and an exhaust conduit 120 that connects to an exhaust valve 142. The remote plasma system 138 features a remote inlet conduit 152 and receives a signal from a processor 130 by interconnect 162. The remote plasma system is in fluid communication with the remote valve 140 and gas mixing block 136 by transport conduit 158. The gas mixing block 136 is connected to the process chamber 110 by transport conduit 154. The processor 130 has an interconnect 184 to receive a signal from an endpoint detector 180 and an interconnect 160 to receive a signal from the gas mixing block 136. The processor 130 is configured to send a signal to the processor memory 132 by interconnect 166, to the power source 134 by interconnect 164, and to the remote plasma system by the interconnect 162. A power source 134, such as an RF source, is connected to faceplate 112 of process chamber 110 by interconnect 170.

Remote plasma system 138 is preferably a toroidally-coupled plasma source such as an Astron™ system commercially available from MKS Corporation of Wilmington, Mass. Alternatively, remote plasma system 138 is a remote microwave plasma system. However, any system capable of dissociating elements to form cleaning radicals remote from process chamber 110 can be used.

Related hardware and process information may be found in U.S. patent application No. 10/910,269 filed on Aug. 3, 2004 and titled “Heated Gas Box for PECVD Applications,” including paragraphs 10-30 and FIGS. 1-5 which are incorporated by reference. Also, related hardware and process information may be found in U.S. Patent Application No. 60/574,823 filed on May 26, 2004 and titled “Blocker Bypass to Distribute Gases in a Chemical Vapor Deposition System,” including paragraphs 9-32 and FIGS. 1-5 which are incorporated by reference.

In operation, diatomic fluorine is generated in a remote plasma region of the processing chamber where a heteroatomic fluorine containing gas is exposed to remote plasma. Heteroatomic fluorine containing gases are gases that have an atom other than fluorine in the fluorine containing molecule. The remote plasma disassociates the fluorine and the other atoms in the gas molecule into ionized atoms. Heteroatomic fluorine containing gas can include nitrogen fluoride, silicon fluoride, and hydrogen fluoride. Approximately greater than 90 percent of the fluorine is dissociated. Alternatively, greater than 40, 60, or 80 percent dissociation can be achieved. In order to reduce chamber damage, the disassociated fluorine atoms substantially combine to form diatomic fluorine as the gas flows into the processing region of the processing chamber. Then, an in situ plasma is applied to the molecular fluorine to provide more uniform dissociation of the fluorine molecules. The ionized molecular fluorine cleans silicon based deposits from the surface of the chamber.

Thus, diatomic fluorine can be generated within the processing chamber, requiring no diatomic fluorine transport along public roads. The use of diatomic fluorine as a cleaning gas also provides a more uniform, predictable plasma for cleaning the chamber. This more uniform, predictable plasma more evenly cleans the chamber and is less likely to deform or degrade the surfaces of the chamber by overcleaning. The ionized diatomic fluorine is a desirable chamber cleaning agent because it is not as destructive to the chamber surfaces as other cleaning agents. The time for cleaning the process chambers may be reduced because the uniform cleaning may also be more efficient. Time for cleaning may also be reduced because multiple cycles for remote and in situ plasmas will be reduced.

The deposits and residue to be cleaned from the chamber surfaces comprises silicon containing substances associated with low dielectric constant deposition processes such as silicon oxide, carbon doped silicon oxide, silicon carbide, or silicon nitride. Additional components of the deposits may comprise carbon or other substances to promote film stability or dielectric properties.

Oxygen may be a component of the gas feed stream to the remote plasma. Oxygen may provide cleaning capabilities when the deposit is an amorphous silicon based deposit or when the deposit comprises carbon.

There are several ways to encourage the formation of diatomic fluorine as the atomic fluorine flows into the processing region of the processing chamber. Increasing the remote plasma pressure, increasing the residence time as the remotely generated plasma flows into the processing region of the chamber, increasing the surface area of the path the remotely generated plasma follows as it flows into the processing region of the chamber, increasing the surface roughness of the surfaces in the chamber, and changing the materials in the transport path may all increase the likelihood of molecular fluorine formation.

In an embodiment, the NF₃ may be introduced into the system at 750 to 2000 sccm. Argon was also introduced at 750 to 2000 sccm. Oxygen was added after the NF₃ and argon plasmas were formed at a flow rate of 200 to 1000 sccm for 1 to 300 seconds. The system was maintained at a temperature of 275 to 450° C. and a pressure between 0 to 400 Torr.

The clean step may be followed by a chamber seasoning step. In one embodiment, the cleaning gases may be evacuated from the chamber and helium and oxygen may be added to the chamber for 1 to 60 seconds. Helium may be introduced into the chamber at a flow rate of 10 to 1000 sccm. Oxygen may be added at a flow rate of 500 to 1500 sccm.

Marathon testing was performed to examine the chamber performance for 2000 substrates. The wafer to wafer film thickness and the particle generation in the chamber test results were consistent over a 2,000 substrate test. The wafer to wafer uniformity was 1.3 percent and the uniformity across the surface of the wafer was 1.4 percent.

A 10,000 substrate marathon test was also performed. There were on average 9 particles larger than 16 μm per substrate. The number of particles was consistent over the 10,000 substrate test. That is, the number of particles did not increase near the end of the trial.

While the foregoing is directed to embodiments of the present invention, other and further embodiments of the invention may be devised without departing from the basic scope thereof, and the scope thereof is determined by the claims that follow.

1. A method for cleaning a semiconductor manufacturing chamber, comprising:
introducing a heteroatomic fluorine containing gas to a remote plasma source;
disassociating the heteroatomic fluorine containing gas;
forming diatomic fluorine;
transporting the diatomic fluorine into a processing region of the chamber; and
ionizing the diatomic fluorine with an in situ plasma.

2. The method of claim 1, wherein the heteroatomic fluorine containing gas comprises nitrogen.

3. The method of claim 1, wherein the heteroatomic fluorine containing gas comprises silicon.

4. The method of claim 1, wherein the heteroatomic fluorine containing gas comprises hydrogen.

5. The method of claim 1, further comprising introducing oxygen with the diatomic fluorine containing gas to the remote plasma source.

6. The method of claim 1, wherein the remote plasma source is a torodially-coupled remote plasma source.

7. The method of claim 1, wherein the remote plasma source applies microwave power.

8. The method of claim 6, wherein the remote plasma source operates at a pressure less than one atmosphere.

9. The method of claim 1, wherein the in situ plasma is formed by supplying RF power.

10. The method of claim 1, wherein the flow rate of the heteroatomic fluorine containing gas is 750 to 2000 sccm.

11. The method of claim 2, wherein the heteroatomic fluorine containing gas is NF₃.

12. A method for cleaning a semiconductor manufacturing chamber, comprising:
introducing a fluorine containing gas to a remote plasma source, wherein the heteroatomic fluorine containing gas is selected from silicon fluoride and hydrogen fluoride;
disassociating the atoms within the heteroatomic fluorine containing gas;
forming diatomic fluorine;
transporting the diatomic fluorine into a processing region of the chamber; and
ionizing the diatomic fluorine with an in situ plasma.

13. The method of claim 12, wherein the in situ plasma is formed by supplying RF power.

14. The method of claim 12, wherein the remote plasma source is a torodially-coupled remote plasma source.

15. The method of claim 14, wherein the remote plasma source operates at a pressure less than one atmosphere.

16. The method of claim 12, wherein the flow rate the of heteroatomic fluorine containing gas is 750 to 2000 sccm.

17. A method for cleaning a semiconductor manufacturing chamber, comprising:
introducing a heteroatomic fluorine containing gas to a remote plasma source, wherein the heteroatomic fluorine containing gas is selected from silicon fluoride and hydrogen fluoride;
disassociating the atoms within the heteroatomic fluorine containing gas;
forming diatomic fluorine;
transporting the diatomic fluorine into a processing region of the chamber; and
ionizing the diatomic fluorine with an in situ plasma, wherein the in situ plasma is formed by supplying RF power.

18. The method of claim 17, wherein the remote plasma source is a torodially-coupled remote plasma source.

19. The method of claim 18, wherein the remote plasma source operates at a pressure less than one atmosphere.

20. The method of claim 19, wherein the flow rate of the heteroatomic fluorine containing gas is 750 to 2000 sccm.
